(19) United States
(12) Patent Application Publication
(10) Pub. No.: US 2005/0099412 A1
(43) Pub. Date: May 12, 2005

(54) Pixel circuit, method of driving the same, and electronic apparatus

(75) Inventor: Toshiyuki Kasai, Okaya-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/930,947

(22) Filed: Sep. 1, 2004

(30) Foreign Application Priority Data
Nov. 11, 2003 (JP) 2003-381271

(51) Int. Cl. G09G 5/00

(52) U.S. Cl. 345/204; 345/694; 345/698

(57) ABSTRACT

To control variation in a driving current depending on Vth in a current program mode pixel circuit. In a state in which a variable current source 4a and a transistor T3 are electrically isolated from each other, a gate voltage of the diode-connected transistor T3 is set to an offset voltage (Vdd−Vth) according to a threshold voltage Vth thereof. Next, in a state in which the variable current source 4a and the transistor T3 are electrically connected to each other, data based on the offset voltage and according to a product of a data current Idata and a supply time thereof are written in a capacitor C1 connected to a gate of the transistor T3. And then, a driving current according to data stored in the capacitor C1 is generated by means of the transistor T3, whereby brightness of an organic EL element OLED is set.

### BACKGROUND OF THE INVENTION

1. Field of Invention

The present invention relates to a pixel circuit, a method of driving the same, and electronic apparatus, and more specifically, it relates to a method of compensating Vth in a current-programmed method.

2. Description of Related Art

Recently, displays using an organic electroluminescent (EL) element draw attention. The organic EL element is one of current-driven type elements in which the brightness is set according to a driving current flowing therethrough. A data supplying method to pixels using the organic EL element includes a voltage-programmed mode in which voltage-based data is supplied to data lines and a current-programmed mode in which current-based data is supplied to the data lines. In the voltage-programmed mode, a problem occurs that variation in a driving current depending on a threshold voltage (hereinafter, referred to as ‘Vth’) of a driving transistor may be caused, but conventionally, the solution is suggested.

FIG. 17 is a diagram of a conventional voltage-programmed mode pixel circuit. The pixel circuit has an organic EL element OLED, a capacitor C1 and three of n-channel type transistors T1 through T3, in which the capacitor C1 is provided between a gate and a source of the transistor T3. The pixel circuit operates as the following processes by means of a swing of a voltage Vca of an opposing electrode. First, if the transistor T1 is turned off and the transistor T2 is turned on, a cathode voltage Vca of the organic EL element OLED is set to −18V. Accordingly, since the transistor T3 is turned on, an anode voltage of the organic EL element OLED becomes lower than −Vth (Vth is a threshold voltage of the transistor T3), and then a voltage higher than Vth is stored in the capacitor C1. Next, if the transistor T2 is turned off, a gate of the transistor T3 is in a floating state. Subsequently, if the cathode voltage Vca is set to 10V, a reverse bias voltage is applied to the organic EL element. Accordingly, the transistor T3 is turned off, and then a gate voltage of the transistor T3 becomes higher than Vth due to a change in the cathode voltage Vca. Subsequently, the transistor T3 is turned on again, and then the anode of the organic EL element OLED becomes almost 0 V. In this state, if the transistor T2 is turned on and the cathode voltage Vca is set to 0 V, the anode voltage of the organic EL element becomes sufficiently low due to a capacitive coupling to be settled to −Vth, and Vth is stored in the capacitor C1. Next, if the transistor T1 is turned on and the transistor T2 is turned off, a data voltage defining grayscale level of a pixel is supplied to the pixel circuit. If a self-capacitance of the organic EL element OLED is set to be sufficiently larger than that of the capacitor C1, the anode voltage of the organic EL element is maintained almost to −Vth when the cathode voltage Vca is 0 V, and in the capacitor C1 a voltage of Vth+Vdata is stored. And then, the transistor T1 and T2 are turned off together, and the cathode voltage Vca is set to −18 V. At this time, since the voltage of Vth+Vdata is stored in the capacitor C1, a channel current (driving current) proportional to the voltage of Vth+Vdata flows through a channel of the transistor T3, whereby the organic EL element OLED is emitted. In such manner, if Vth is previously stored in the capacitor C1 and data is written based on Vth, variation in Vth of the transistor T3 can be compensated, and further a driving current independent of Vth can be generated.

### SUMMARY OF THE INVENTION

Meanwhile, the current-programmed mode, unlike the voltage-programmed mode, is generally advantageous in that an uniform driving current independent of Vth of a driving transistor can be generated. For this reason, the current-programmed mode is widely adopted. However, the current-programmed mode is made on the assumption that current-based data (current data) is written completely within a predetermined data writing period. Accordingly, if the data writing is not completed within the predetermined period, that is, the data writing is lacking, when the same grayscale is displayed, the driving current which must be primarily the same for every driving transistor may be differentiated depending on variation in Vth. This may be generated in a large-sized display in which a parasitic capacitance of a data line is very large and a high-definition display in which the number of scanning lines is numerous and a data writing period is not sufficiently secured. Further, in the case that a current to be programmed in a pixel is very small (when using high efficient EL element or phosphorescence material, the above problem may also occur. Besides, in the case that a security of a contrast ratio is preceded, for design convenience, lack writing in a low-resolution grayscale region may be tolerated at a certain degree, and the current to be programmed may be set in a wider range.

The present invention has been made in consideration of the above problems, and its object is to suppress variation in a driving current depending on Vth in a current-programmed mode pixel circuit.

In order to solve the above problems, there is provided a method of driving a pixel circuit according to a first aspect of the present invention. The driving method comprises: a first step of setting a gate voltage of a diode-connected first transistor to an offset voltage according to a threshold voltage of the first transistor, in a state in which a variable current source variably generating a data current is electrically isolated from the first transistor, a second step of writing, in a capacitor connected to a gate of the diode-connected first transistor, data set based on the offset voltage and according to a product of the data current supplied from the variable current source via data lines and a supply time thereof, in a state in which the variable current source and the first transistor are electrically connected to each other, and a third step of generating a driving current according to the data stored in the capacitor by a second transistor whose gate is connected to the capacitor to set brightness of an electro-optical device.

In the first aspect, a transistor rolls as both the first transistor and the second transistor. Further, the first transistor and the second transistor may constitute a current mirror.

Further, in the first aspect, preferably, the first step comprises a step of turning off a switching element provided between the variable current source and the first transistor, and the second step comprises a step of turning on the switching element. Further, in the first aspect, the driving method may further comprise a fourth step of regulating the offset voltage set in the first step, by variably controlling the terminal voltage of a capacitor that another terminal is coupled to the data lines.

In this case, the amount of change of the terminal voltage of a capacitor in the fourth step is set according to a grayscale level to be displayed.

Further, the driving method may comprise, prior to setting the offset voltage in the first step, a fifth step of supplying, to the data lines, a predetermined voltage having a voltage level that turns on the first transistor.

More, there is provided a pixel circuit according to a second aspect of the present invention. The pixel circuit comprises: a first transistor normally or selectively diode-connected through a control of a switching transistor, for generating data according to data current supplied from a variable current source via the data lines, a capacitor connected to a gate of the first transistor, in which data generated by the first transistor is written, a second transistor, whose gate is connected to the capacitor, for generating a driving current according to data stored in the capacitor, and an electro-optical element in which the brightness is set according to the driving current generated by the second transistor. Here, the first transistor sets its gate voltage to an offset voltage according to its threshold voltage in a state which the first transistor is electrically isolated from the variable current source. Further, in a state which the first transistor is electrically connected to the variable current source, the first transistor writes data set based on the offset voltage and according to a product of the data current supplied from the variable current source and a supply time thereof, in the capacitor.

In the second aspect, a transistor may rolls as both the first transistor and the second transistor. Further, the first transistor and the second transistor may constitute a current mirror.

Further, in the second aspect, the pixel circuit may further comprises a switching circuit for electrically isolating between the variable current source and the data line for a period during which the gate voltage is set to the offset voltage, and electrically connecting between the variable current source and the data line for a period during which the data is written in the capacitor. Further, the pixel circuit may further comprise a precharge regulation circuit that regulate the offset voltage by variably controlling the terminal voltage of a capacitor that another terminal is coupled to the data lines. In this case, the precharge regulation circuit preferably controls the amount of change of the terminal voltage of a capacitor according to a grayscale level to be displayed. In addition, the pixel circuit may further comprise a precharge acceleration circuit for supplying, to the data lines, a predetermined voltage having a voltage level that turns on the first transistor, prior to a period during which the gate voltage is set to the offset voltage.

More, there is provided an electronic apparatus according to a third aspect of the present invention. The electronic apparatus comprises an electro-optical device having a pixel circuit according to the second aspect of the present invention.

In the present invention, the gate voltage of the first transistor is previously set to the offset voltage, and the data writing to the capacitor is made in the current-programmed mode. Data to be written is set based on the offset voltage previously set and according to the product of the data current and the supply time thereof. Thus, when the driving current is generated based on data stored in the capacitor, it is possible to reduce a dependency on Vth of the driving current. As a result, even when data writing is lacking, it is possible to generate an uniform driving current, and thus it is possible to set the electro-optical device to have a desirable brightness.

### BRIEF DESCRIPTION OF THE DRAWINGS

FIG. 1 is a block diagram showing a configuration of an electro-optical device;

FIG. 2 is a diagram of a pixel circuit according to a first embodiment;

FIG. 3 is a timing chart of operation according to the first embodiment;

FIG. 4 is an explanatory view of the operation according to the first embodiment;

FIG. 5 is a diagram of a pixel circuit according to a second embodiment;

FIG. 6 is a timing chart of operation according to the second embodiment;

FIG. 7 is a diagram of a pixel circuit according to a third embodiment;

FIG. 8 is a timing chart of operation according to the third embodiment;

FIG. 9 is a diagram of a pixel circuit according to a fourth embodiment;

FIG. 10 is a timing chart of operation according to the fourth embodiment;

FIG. 11 is a diagram of a pixel circuit according to a fifth embodiment;

FIG. 12 is a timing chart of operation according to the fifth embodiment;

FIG. 13 is an explanatory view of the operation according to the fifth embodiment;

FIG. 14 is a diagram of a pixel circuit according to a sixth embodiment;

FIG. 15 is a timing chart of operation according to the sixth embodiment;

FIG. 16 is an explanatory view of the operation according to the sixth embodiment;

FIG. 17 is a diagram of a conventional pixel circuit.

### DETAILED DESCRIPTION OF PREFERRED EMBODIMENTS

### First Embodiment

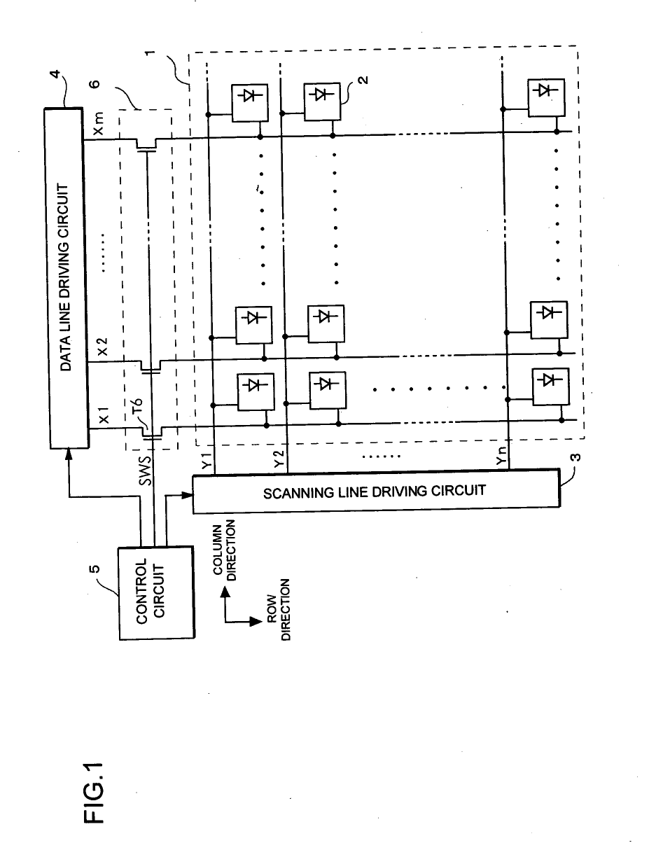

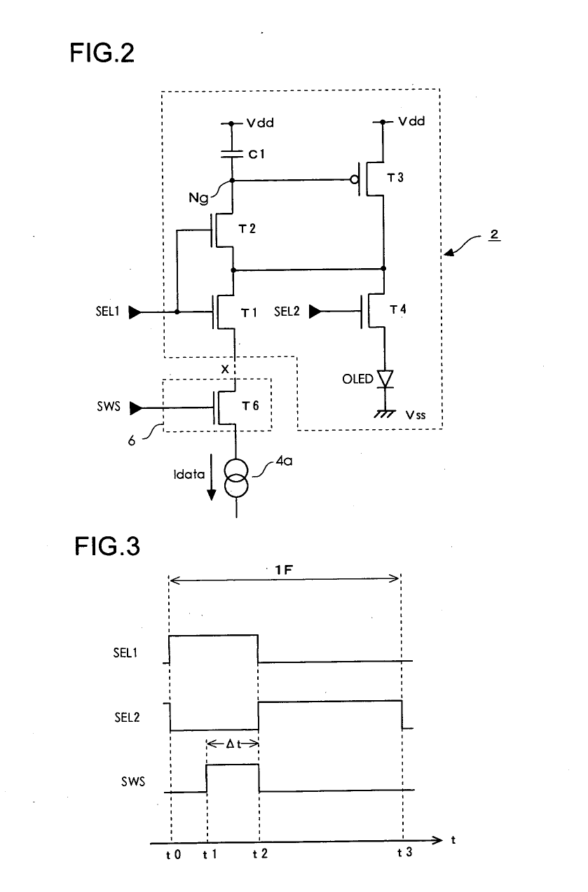

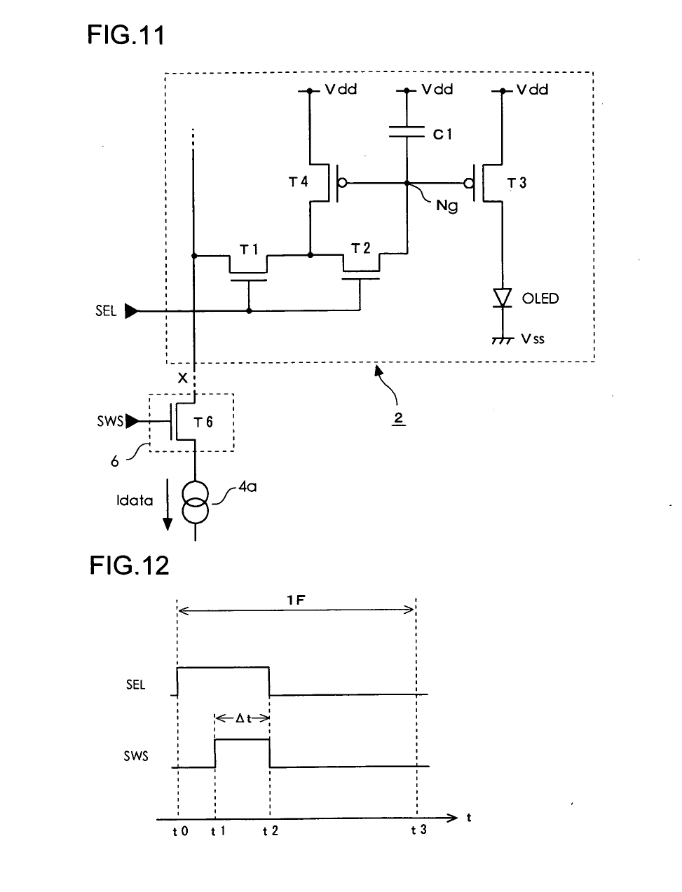

FIG. 1 is a block diagram showing a configuration of an electro-optical device according to the present embodiment. A display unit 1 is, for example, an active matrix type display panel in which the electro-optical device is driven by a TFT (thin film transistor). In the display unit 1, m dots by n lines of a group of pixels are arranged in a matrix (in a two-dimensional plan view). In the display unit 1, a group of scanning lines Y1 through Yn each extending in a horizontal direction and a group of data lines X1 through Xm each extending in a vertical direction are provided, and pixels 2 are arranged in correspondence with intersections of the scanning lines and the data lines. Moreover, while in a monochromatic panel, one pixel corresponds to one pixel circuit described below, when one pixel comprises three R, G, B sub-pixels like a color panel, one sub-pixel corresponds to one pixel circuit. Further, as regards the configuration of the pixel circuit described below, one scanning line may represent a respective one of scanning lines (FIG. 11) or may represent a set of plural scanning lines (FIGS. 2, 5, 7, 9 and 14).

A control circuit 5 synchronously controls a scanning line driving circuit 3, a data line driving circuit 4 and a switching circuit 6 based on a vertical synchronizing signal Vs, a horizontal synchronizing signal Hs, a dot clock signal DCLK, grayscale data D, and so on, which are inputted from preceding devices. Under the synchronous control, the scanning line driving circuit 3, the data line driving circuit 4 and the switching circuit 6 cooperate with each other to control a display on the display unit 1.

The scanning line driving circuit 3 mainly comprises shift registers, output circuits, and so on, and outputs a scanning signal SEL to the scanning lines Y1 through Yn to perform a line sequential scanning. The scanning signal SEL is a two-level signal of a high potential level (hereinafter, referred to as ‘H level’) and a low potential level (hereinafter, referred to as ‘L level’). A scanning line corresponding to a row of pixels to which data is written is set to H level and other scanning lines are set to L level. The scanning line driving circuit 3 performs the line sequential scanning for selecting each scanning line Y in a predetermined order (in general, from top to bottom) for every period (1F) in which images of one frame are displayed. Meanwhile, the data line driving circuit 4 has mainly shift registers, line latch circuits, output circuits, and so on. In the present embodiment, if the current-programmed mode is adopted, the data line driving circuit 4 comprises a variable current source (4a in FIG. 2) for variably generating a data current Idata based on grayscale data defining grayscale level to be displayed in the pixel 2. In one horizontal scanning period (1H) corresponding to the period in which one scanning line is selected, the data line driving circuit 4 simultaneously outputs the data current Idata to a row of pixels to which current data is written, and at the same time, latches in a point sequential manner data relevant to a row of pixels to be written in next one horizontal scanning period (1H). In any horizontal scanning period (1H), m data corresponding to the number of data lines X are sequentially latched. And then, in next one horizontal scanning period (1H), the latched m data are converted into current data Idata by means of the variable current source, and are simultaneously output to the corresponding data lines. Further, the switching circuit 6 comprising m switching elements, more specifically, m switching transistors T6 corresponding to the data lines X1 through Xm. The transistors T6 provided by one for every data line are, for example, n-channel type transistors and are commonly controlled by a single switching signal SWS outputted from the control circuit 5. This control is performed in synchronization with the line sequential scanning by means of the scanning line driving circuit 3.

FIG. 2 is a diagram of a current-programmed mode pixel circuit according to the present embodiment. One pixel 2 comprises an organic EL element OLED, four transistors T1 through T4 as an active element, and a capacitor C1 storing data. The organic EL element represented as a diode is a typical current-driven type element in which the brightness is set by a current Ioled flowing therethrough. In this configuration example, the n-channel type transistors T1, T2 and T4 and the p-channel type transistor T3 are used, but it is just an example. Thus, the channel types of the respective transistors T1 through T4 may be set differently from the above channel type combination. Further, between the data line X connected to the pixel 2 and the variable current source 4a constituting a portion of the data line driving circuit 4, a single switching transistor T6 provided by one for every data line is connected. In the present specification, as regards a three-terminal type transistor having a source, a drain and a gate, one of the source and drain is referred to as ‘one terminal’ and the other is referred as ‘the other terminal’.

A gate of the switching transistor T1 is connected to one scanning line to which a first scanning signal SEL1 is supplied, and one terminal of the switching transistor T1 is connected to one data line X to which the data current Idata is supplied. The other terminal of the switching transistor T1 is commonly connected to one terminal of the switching transistor T2, one terminal of the driving transistor T3 and one terminal of the driving transistor T4. A gate of the switching transistor T2 is connected to the scanning line to which the first scanning signal SEL1 is supplied, like the first switching transistor T1. The other terminal of the switching transistor T2 is connected to a node Ng to which one electrode of the capacitor C1 and a gate of the driving transistor T3 are commonly connected. To the other electrode of the capacitor C1 and the other terminal of the driving transistor T3, a Vdd terminal is connected, through which a power source voltage is constantly supplied. The switching transistor 4 is provided between one terminal of the driving transistor T3 of which a gate is supplied with a second scanning signal SEL2 and an anode of the organic EL element OLED. A cathode of the organic EL element OLED is connected to a Vss terminal to which a reference voltage Vss lower than the power source voltage Vdd is constantly supplied. Moreover, in this configuration example, the driving transistor T3 functions a programming element for wiring data according to the data current Idata in the capacitor C1, as well as a driving element for generating the driving current Ioled primarily.

FIG. 3 is a timing chart of operation of the pixel circuit shown in FIG. 2. In a period t0 to t3 corresponding to one frame period (1F) described above, consecutive processes are generally divided into a precharge process in an initial period t0 to t1, a data writing process in a subsequent period t1 to t2, and a driving process in a last period t2 to t3.

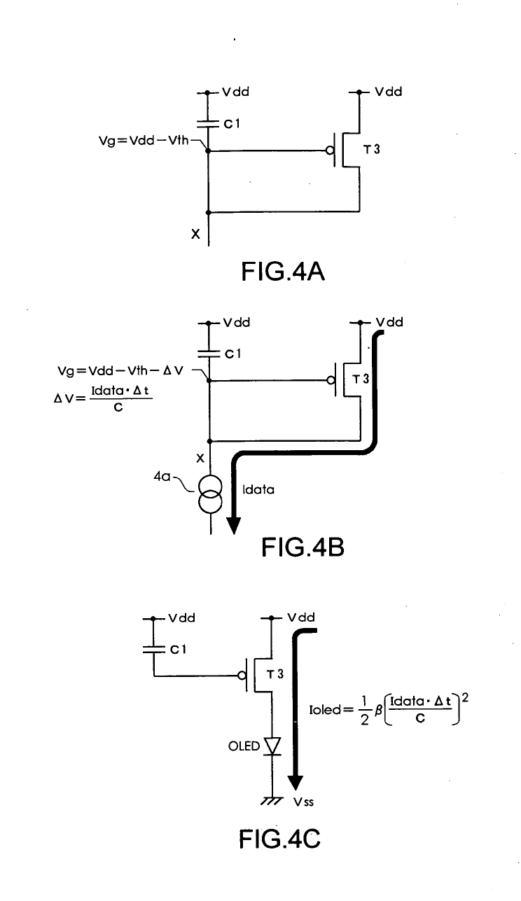

First, in the precharge period t0 to t1, a precharge to be completed within the pixel 2 is performed, and by means of this precharge, a Vth compensation of the driving transistor T3 is performed. More specifically, the level of the first scanning signal SEL1 becomes H level, and then the switching transistors T1 and T2 are turned on together. Accordingly, the data line and one terminal (drain) of the driving transistor T3 are electrically connected to each other, and thus the driving transistor T3 becomes a diode-connection in which its gate and its drain are electrically connected to each other. In this period t0 to t1, since the level of the switching signal is L level and the switching transistor T6 is turned off, the node Ng in the pixel 2 and the variable current source 4a are still electrically isolated from each other. Further, the level of the second scanning signal SEL2 becomes L level, and then the switching transistor T4 is turned off. Accordingly, as shown in FIG. 4(a), in a state in which the node Ng and the variable current source 4a are electrically isolated from each other, the precharge of the capacitor C1 and the data line X is performed by means of the power source voltage Vdd of the Vdd terminal. By means of this precharge, a voltage of the node Ng, that is, a gate voltage Vg of the driving transistor T3 is set to an offset voltage (Vdd−Vth), and its voltage level is principally determined by means of the threshold voltage Vth of the driving transistor T3. In such manner, prior to writing data, the voltage Vg of the node Ng is forcibly offset from a voltage level depending on data written in the driving process of the previous one frame period (1F), to the offset voltage (Vdd−Vth) corresponding to a precharge level. Moreover, in this period t0 to t1, since the switching transistor T4 is turned off, the organic EL element OLED does not emit.

Next, in the data writing period t1 to t2, based on the offset voltage (Vdd−Vth) set in the previous precharge period t0 to t1, the data is written in the capacitor C1. In this period t1 to t2, since the scanning signals SEL1 and SEL2 are respectively at the same level as those in the precharge period t0 to t1, the switching transistors T1 and T2 are left to be turned on, and the switching transistor T4 is left to be turned off. Further, in the timing t1, the level of the switching signal SWS rises to H level, and then the switching transistor T6 which is turned off is switched to be turned on. In such manner, as shown in FIG. 4(b), the node Ng and the variable current source 4a are electrically connected to each other. As a result, a path of the data current Idata is formed, and the path is made in a sequence of the Vdd terminal, a channel of the driving transistor T3 and the variable current source 4a (correctly speaking, channels of the switching transistors T1 and T6 also are included). The voltage Vg of the node Vg is calculated by means of the following equation 1.
Vg=Vdd−Vth−ΔV
ΔV=(Idata·Δt)/C (Equation 1)

Here, Idata is a voltage level of the data current Idata generated by the variable current source 4a, Δt is a time in the data writing period t1 to t2, that is, a supply time of the data current Idata. Further, a coefficient C is a total capacitance relating to a driving path of the data current Idata including a wiring capacitance of the data line X and a capacitance of the capacitor C1. As seen from the equation 1, the voltage Vg is changed by ΔV based on the offset voltage (Vdd−Vth), and the ΔV is principally specified according to a product of the data current Idata and its supply time Δt. Thus, in the capacitor C1, charges according to the voltage Vg are written as data. Moreover, in the period t1 to t2, like the previous precharge period t0 to t1, the switching transistor T4 is left to be turned off, and thus the organic EL element OLED does not emit.

Further, in the driving period t2 to t3, the driving current Ioled corresponding to a channel current of the driving transistor T3 is supplied to the organic EL element OLED, whereby the organic EL element is emitted. More specifically, levels of the first scanning signal SEL1 and the switching signal SWS fall to L level, the switching transistors T1, T2 and T6 are turned off together. Accordingly, the node Ng is electrically isolated from the variable current source 4a. However, even after the electrical isolation, to the gate of the driving transistor T3, a voltage according to data stored in the capacitor C1 is continuously applied. Further, in ‘synchronization’ with the falling of the first scanning signal SEL1, the level of the second scanning signal SEL2 rises to H level. In the present specification, the term ‘synchronization’ is used to represent a tolerable time offset to a margin for design as well as the same timing. In such manner, as shown in FIG. 4(c), along a sequential path of the Vdd terminal, the channel of the driving transistor T3, the organic EL element OLED and the Vss terminal, the driving current Ioled flows. On an assumption that the driving transistor T3 operates in a saturation region, the driving current Ioled (a channel current Isd of the driving transistor T3) flowing through the organic EL element OLED is calculated by the following equation 2. In the equation 2, a Vsg is a voltage between the gate and the source of the driving transistor T3. Further, a gain coefficient β is principally specified by a mobility μ of carrier, a gate capacitance A, a channel width W and a channel length L of the driving transistor T3 (β=μA W/L).
Ioled=Isd=½β(Vsg−Vth)² (Equation 2)

Here, if the Vg calculated by the equation 1 is substituted for the gate voltage of the driving transistor T3, the equation 2 is transformed to the following equation 3.
Ioled=½β(Vs−Vg−Vth)²=½β{Vdd−(Vdd−Vth−ΔV)−Vth}²=½β·ΔV²=β/2(Idata·Δt/C)² (Equation 3)

In the equation 3, it is important that the Vths are balanced each other during the equation transformation. This means that the driving current Ioled to be generated by the driving transistor T3 does not depend on the Vth. The emitting brightness of the organic EL element OLED is principally determined by the driving current Ioled according to the product of the data current Idata and its supply time Δt, and thus grayscale level of the pixel 2 is set.

In such manner, in the present embodiment, in the precharge prior to the data writing, the voltage of the node Ng is set to the offset voltage (Vdd−Vth) and data is written in the capacitor C1 based on the product of the data current Idata and its supply time Δt. In general, variation in the Vth is larger than that of the Δt or the C, and therefore, by compensating the Vth, the degree of the precharge in each pixel 2 becomes equivalent even when characteristics of the driving transistor T3 in the display unit 1 are uneven. As a result, even in the case that the data writing is lacking as describe above, it is possible to suppress variation in the driving current depending on the Vth and thus improve display quality still more.

Further, according to the present embodiment, it is possible to perform the precharge to be completed within the pixel 2, without providing an additional circuit for precharge outside the pixel 2. This is advantageous for simplifying a configuration of the circuit or reducing the power consumption.

### Second Embodiment

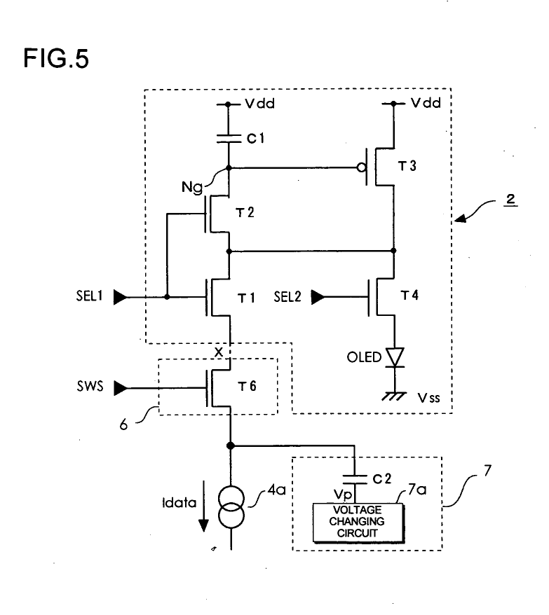

The present embodiment relates to a technique for regulating the offset voltage (Vdd−Vth) corresponding to the precharge level according to a grayscale level to be displayed, based on the basic configuration of the first embodiment described above. FIG. 5 is a diagram of a pixel circuit according to the present embodiment. The pixel circuit has a feature that a precharge regulation circuit 7 is added to the pixel circuit shown in FIG. 2, and other elements are the same as those of the pixel circuit of FIG. 2. Thus, the descriptions of like elements will be omitted. The precharge regulation circuit 7 comprises a capacitor C2 and a voltage changing circuit 7a for variably setting an output voltage Vp. To one electrode of the capacitor C2, one terminal of the switching transistor T6 constituting a portion of the switching circuit 6 and a connecting terminal with the variable current source 4a are connected. Further, to the other electrode of the capacitor 2, an output terminal of the voltage changing circuit 7a is connected, and then a voltage level of the voltage Vp of the output terminal is variably controlled according to grayscale.

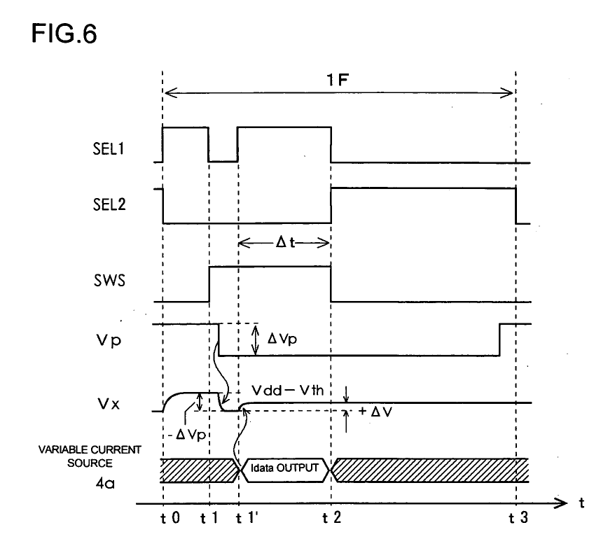

FIG. 6 is a timing chart of operation of the pixel circuit shown in FIG. 5. A period t0 to t3 corresponding to one frame period (1F) is generally divided into a precharge period t0 to t1, a precharge regulation period t1 to t1′, a data writing period t1′ to t2 and a driving period t2 to t3. The present embodiment is different from the first embodiment in that the precharge regulation period t1 to t1′ is provided between the precharge period t0 to t1 and the data writing period t1′ to t2, but other processes are basically the same as those of the first embodiment. The variable current source 4a, in the data writing period t1′ to t2, outputs the data current Idata to the data line X, and, in other periods, is set to a state of high impedance, that is, a state which is electrically isolated from the pixel 2.

First, in the precharge period t0 to t1, the level of the first scanning signal SEL1 becomes H level, and thus the driving transistor T3 is diode-connected and the data line X and the node Ng are electrically connected to each other. Further, in this period t0 to t1, since the level of the switching signal SWS is L level, and the switching transistor T6 is turned off, the data line X is electrically isolated from the variable current source 4a and the precharge regulation circuit 7. Accordingly, the capacitor C1 and the data line X are precharged, the voltage Vg of the node Ng and a voltage Vx of the data line X are set to the offset voltage (Vdd−Vth) as the precharge level.

In the next precharge regulation period t1 to t1′, the level of the first scanning signal SEL1 becomes temporally L level, and thus the switching transistors T1 and T2 are turned off together. At the same time, the level of the switching signal SWS becomes H level, and thus the switching transistor T6 is turned on. In this period t1 to t1′, while maintaining the variable current source 4a as high impedance state, the previously set precharge level (Vdd−Vth) is regulated. More specifically, in any timing of this period t1 to t1′, the voltage changing circuit 7a which is a portion of the precharge regulation circuit 7 lowers the output voltage Vp by ΔVp stepwise from a current voltage level. Accordingly, on an assumption that a wiring capacitance of the data line X is sufficiently larger than a capacitance of the capacitor C2, the voltage Vx of the data line X which is capacitively coupled via the capacitor C2 is lowered by ΔVp (Vx=Vdd−Vth−ΔVp) based on the previously set offset voltage (Vdd−Vth). Here, ΔVp which corresponds to a regulation amount of the precharge level is variably set according to a grayscale level of the pixel 2 to be displayed next time. That is, in low-resolution grayscale in which the data current Idata is relatively small, ΔVp becomes small, and then the voltage Vx (precharge level) of the data line X is set to be high. In such manner, in the subsequent data writing process, a load required for charging the data line X and the capacitor C1 can be reduced, and further a lack data writing can be suppressed. Meanwhile, in high-resolution grayscale in which the data current Idata is relatively large, ΔVp becomes larger than that of the low-resolution grayscale, and then the precharge level is set to be low.

In the subsequent data writing period t1′ to t2, the level of the first scanning signal SEL1 rises to H level again, and thus the node Ng and the variable current source 4a are electrically connected to each other. Accordingly, the data writing based on the offset voltage (Vdd−Vth) is performed. In such manner, the voltage Vx of the data line X rises or falls by a voltage value ΔV depending on the data current Idata, based on the previously set voltage (Vdd−Vth−ΔVp). Further, in the driving period t2 to t3, the driving current Ioled generated by the driving transistor T3 flows in the organic EL element OLED, whereby the organic EL element OLED is emitted. Similarly to the first embodiment, the driving current Ioled is specified by the product of the data current Idata and its supply time Δt, and does not depend on the Vth of the driving transistor T3.

As described above, according to the present embodiment, similarly to the first embodiment, it is possible to suppress variation in the driving current Ioled depending on the Vth of the driving transistor T3. Further, in the present embodiment, the precharge level is regulated according to a grayscale level of the pixel 2 to be displayed. Accordingly, it is possible to perform efficiently the data writing over all of grayscale regions without causing the lack data writing. Moreover, in the present embodiment, the regulation of the precharge level may be set regardless of grayscale level of the pixel 2 to be displayed, that is, may function so as to change simply a value of the offset voltage. In this case, the precharge regulation circuit 7 can be simplified.

Moreover, the precharge regulation technique described in the present embodiment can be applied similarly to pixel circuits according to fifth and sixth embodiments described below.

### Third Embodiment

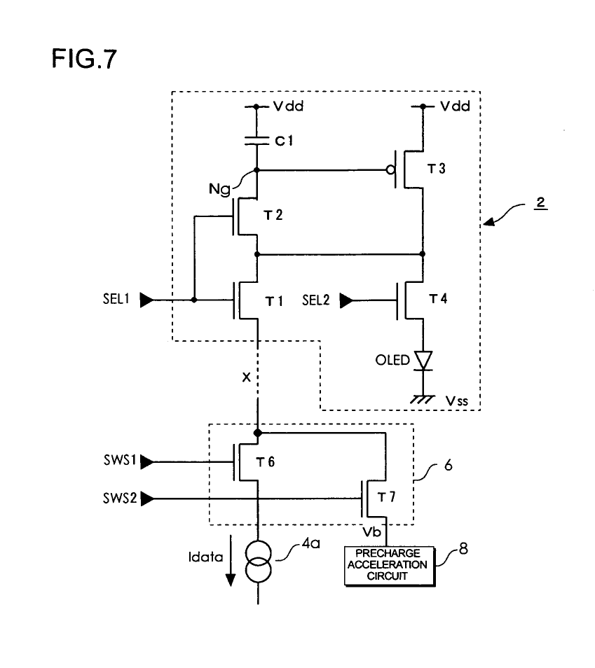

The present embodiment relates to a technique for accelerating the precharge, based on the basic configuration of the first embodiment described above. FIG. 7 is a diagram of a pixel circuit according to the present embodiment. The pixel circuit has two features. The first feature is that a precharge acceleration circuit 8 is added to the pixel circuit shown in FIG. 2. The precharge acceleration circuit 8 is a circuit for outputting a predetermined voltage Vb. The voltage Vb is preferably in vicinities of the above-mentioned offset voltage (Vdd−Vth), but may be less than a voltage such that the driving transistor T3 is turned on, (Vdd−Vth). The second feature is that the switching circuit 6 comprises a group of two switching transistors T6 and T7. The switching transistor T6 is provided between the data line X and the variable current source 4a, and is controlled by a first switching signal SWS1. Further, the switching transistor T7 is provided between the data line X and the precharge acceleration circuit 8, and is controlled by a second switching signal SWS2.

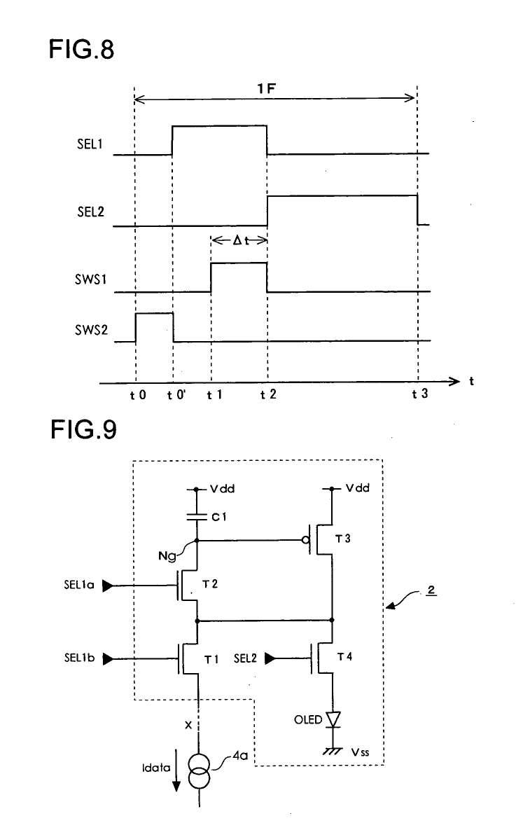

FIG. 8 is a timing chart of operation of the pixel circuit shown in FIG. 7. A period t0 to t3 corresponding to one frame period (1F) is generally divided into a precharge acceleration period t0 to t0′, a precharge period t0′ to t1, a data writing period t1 to t2 and a driving period t2 to t3. The present embodiment is different from the first embodiment in that the precharge acceleration period t0 to t0′ is provided prior to the precharge period t0′ to t1, and other processes are the same as those of the first embodiment.

First, in the precharge acceleration period t0 to t0′, the first scanning signal SEL1 and the first switching signal SWS1 are at L level, and then the switching transistors T1, T2 and T6 are turned off together. Accordingly, the data line X is electrically isolated from the node Ng and the variable current source 4a. In this state, the level of the second switching signal SWS2 becomes H level, and then the switching transistor T7 is turned on. Thus, the output voltage Vb from the precharge acceleration circuit 8 is supplied to the data line X, such that the data line X is precharged. If the precharge acceleration process is not provided, in the precharge period t0 to t1, the precharge operation is performed with a current value close to a turn-off current of the driving transistor T3, and thus it is required for a certain degree of time to precharge. Therefore, in the present embodiment, prior to the precharge, the output voltage Vb is supplied to the data line X such that the driving transistor T3 is turned on. Thus, the drain voltage of the driving transistor T3 is set to a value close to the offset voltage (Vdd−Vth), whereby it is possible to assist and accelerate the operation of the subsequent precharge period t0′ to t1.

The subsequent operation is the same as that of the first embodiment, and will be schematically described herein. In the precharge period t0′ to t1, the precharge is performed by means of the diode-connected driving transistor T3, and the voltage Vg of the node Ng is set to the offset voltage (Vdd−Vth). In the data writing period t1 to t2, data according to the product of the data current Idata and its supply time Δt is written, based on the offset voltage (Vdd−Vth) set in the previous precharge period t0 to t1. And then, in the driving period t2 to t3, the driving current Ioled which does not depend on the Vth of the driving transistor T3 flows in the organic EL element OLED, whereby the organic EL element is emitted.

As described above, according to the present embodiment, like the respective embodiments described above, it is possible to suppress variation in the driving current Ioled depending on the Vth of the driving transistor T3. Further, in the present embodiment, prior to the precharge, the process for turning on the driving transistor T3 is further provided. Thus, since the subsequent precharge can be completed in a relatively short time, it is possible to alleviate a time limit in a series of operation processes.

Moreover, the precharge acceleration technique described in the present embodiment can be applied similarly to the pixel circuits according to the fifth and sixth embodiments described below. However, in case of an application to the sixth embodiment, it is preferable to set the output voltage Vg of the precharge acceleration circuit 8 in vicinities of the offset voltage (V1+Vth).

### Fourth Embodiment

The present embodiment is to implement the operation similar to the first embodiment, without providing the switching circuit 6 shown in FIG. 1. FIG. 9 is a diagram of a pixel circuit according to the present embodiment. This configuration example has a feature that the switching transistor T1 and T2 in the pixel 2 are controlled the respective scanning signals SEL1a and SEL1b, instead of using the switching transistor T6 shown in FIG. 2. Moreover, other elements are the same as those of the first embodiment, and thus the descriptions of like elements will be omitted.

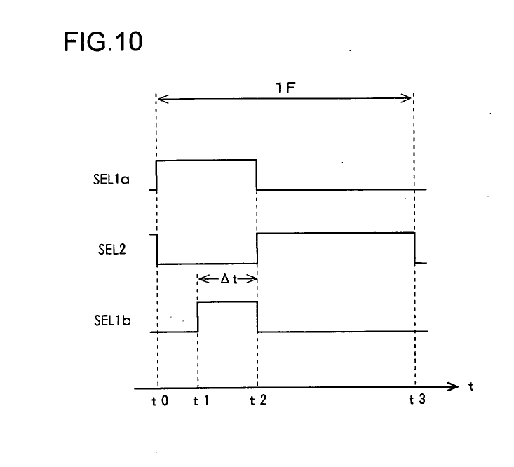

FIG. 10 is a timing chart of operation of the pixel circuit shown in FIG. 9. A period t0-t3 corresponding to one frame period (1F) is generally divided into a precharge period t0-t1, a data writing period t1-t2, and a driving period t2-t3. The present embodiment is different from the first embodiment in that an ending timing t1 of the precharge (in other words, a starting timing of the data writing) is defined by a rising of the scanning signal SEL1b.

First, in the precharge period t0 to t1, since the level of the scanning signal SEL1a is H level and the switching transistor T2 is turned on, the driving transistor T3 is diode-connected. However, in this period t0 to t1, since the level of the scanning signal SEL1b is L level and the switching transistor T1 is turned off, the node Ng is left to be electrically isolated from the variable current source 4a. As a result, until the node Ng reaches the offset voltage (Vdd−Vth), the precharge of the capacitor C1 is performed. In the subsequent data writing period t1 to t2, the level of the scanning signal SEL1b rises to H level, the node Ng and the variable current source 4a are electrically connected, and thus the data writing based on the offset voltage (Vdd−Vth) is performed. Further, in the driving period t2-t3, the driving current Ioled generated by the driving transistor T3 flows in the organic EL element OLED, whereby the organic EL element is emitted. Like the first embodiment, the driving current Ioled is determined by the product of the data current Idata and its supply time Δt, not depending on the Vin of the driving transistor T3.

According to the present embodiment, even when the switching circuit 6 is provided outside the pixel 2, the precharge with the Vth compensated becomes possible. Thus, it is possible to suppress variation in the driving current Ioled depending on the Vth, and further it is possible to simplify the entire configuration of the electro-optical device.

### Fifth Embodiment

The respective embodiments described above are not limited to the pixel circuit shown in FIG. 2, but may be widely applied to a current-programmed mode pixel circuit including a configuration example of a current mirror type described below. FIG. 11 is a diagram of a pixel circuit according to the present embodiment. One pixel 2 comprises an organic EL element OLED, four transistors T1 through T4 and a capacitor C1. Moreover, in this configuration example, the driving transistor T3 functions only as a driving element, and the function of the programming element is implemented by a different programming transistor T4. Further, in the present embodiment, the n-channel type transistors T1 and T2 and the p-channel type transistors T3 and T4 are used, but it is just an example, and the channel types of the respective transistors T1 through T4 may be set differently from the above channel type combination.

The gate of the switching transistor T1 is connected to the scanning line to which the scanning signal SEL is supplied, and one terminal of the switching transistor T1 is connected to the data line X to which the data current Idata is supplied. The other terminal of the switching transistor T1 is commonly connected to one terminal of the switching transistor T2 and one terminal of the programming transistor T4. The gate of the switching transistor T2 is connected to the scanning line to which the scanning signal SEL is supplied, and the other terminal of the switching transistor T2 is connected to the node Ng. To the node Ng, the respective gates of a pair of the transistors T3 and T4 which constitute the current mirror and one electrode of the capacitor C1 are commonly connected. To one terminal of the driving transistor T3, the other terminal of the programming transistor T4 and the other electrode of the capacitor C1, the Vdd terminal is connected, to which the power source voltage Vdd is constantly supplied. To the other terminal of the driving transistor T3, the anode of the organic EL element OLED is connected, and to the cathode of the organic EL element OLED, the Vss terminal is connected, to which a reference voltage Vss is constantly supplied. The transistors T3 and T4 constitute a current mirror in which the gates of the transistors T3 and T4 are connected to each other. Accordingly, a current level of the data current Idata flowing in a channel of the programming transistor T4 is proportional to a current level of the driving current Ioled flowing in a channel of the driving transistor T3.

FIG. 12 is a timing chart of operation of the pixel circuit shown in FIG. 11. A period t0-t3 corresponding to one frame period (1F) is generally divided into a precharge period t0-t1, a data writing period t1-t2 and a driving period t2-t3.

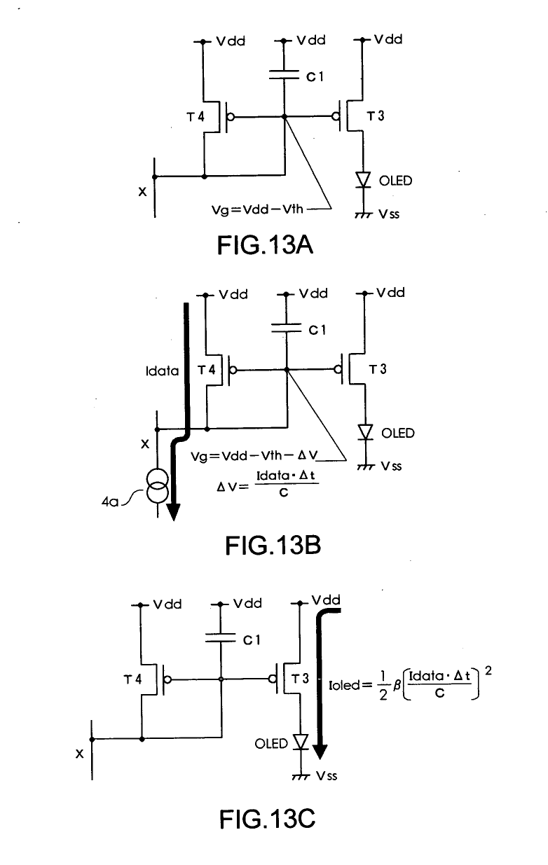

First, in the precharge period t0-t1, the precharge with the Vth compensated is performed. More specifically, the level of the scanning signal SEL becomes H level, and then the switching transistors T1 and T2 are turned on together. Thus, the data line X and one terminal (drain) of the programming transistor T4 are electrically connected, and further the programming transistor T4 is diode-connected in which its gate and its drain are electrically connected. In this period t0 to t1, since the level of the switching signal SWS is L level and the switching transistor T6 is turned off, the node Ng in the pixel 2 and the variable current source 4a are still left to be electrically isolated from each other. Thus, as shown in FIG. 13(a), the precharge of the capacitor C1 and the data line X is performed by the power source voltage Vdd of the Vdd terminal. By this precharge, the voltage of the node Vg, that is, the gate voltage Vg of the programming transistor T4 becomes the offset voltage (Vdd−Vth) depending on a threshold voltage Vth4 of the programming transistor T4.

Moreover, the electrical isolation of the node Ng and the variable current source 4a may be implemented by setting the variable current source 4a to a high impedance state, or may be implemented by controlling respectively the switching transistors T1 and T2. In case of adopting the above isolation techniques, the switching transistor T6 constituting the switching circuit 6 is not required. The same can be applied to the sixth embodiment described below.

Next, in the data writing period t1-t2, the data writing to the capacitor C1 is performed, based on the offset voltage (Vdd−Vth4) set in the previous precharge period t0-t1. In this period t1 to t2, since a level of the scanning signal SEL is the same as that of the precharge period t0-t1, the switching transistors T1 and T2 are left to be turned on. Further, in the timing t1, the level of the switching signal SWS rises to H level, the switching transistor T6 which is turned off is switched to be turned on. Thus, as shown in FIG. 13(b), the node Ng and the variable current source 4a are electrically connected to each other. As a result, a path of the data current Idata is formed, and the path is made in a sequence of the Vdd terminal, the channel of the programming transistor T4 and the variable current source 4a. As shown in the following equation 4, the voltage Vg of the node Ng is changed according to the product of the data current Idata and its supply time Δt, based on the previously set offset voltage (Vdd−Vth4). In the capacitor C1, charges corresponding to the voltage Vg are written as data. Moreover, in this period t1-t2, a path is formed in a sequence of the Vdd terminal, the driving transistor T3, the organic EL element OLED and the Vss terminal, and thus the driving current flows in the organic EL element OLED, whereby the organic EL element OLED starts to be emitted.
Vg=Vdd−Vth4−ΔV
ΔV=(Idata·Δt)/C (Equation 4)

In the subsequent driving period t2-t3, the driving current Ioled corresponding to a channel current Isd of the driving transistor T3 is supplied to the organic EL element OLED, and thus grayscale level of the pixel 2 is defined. More specifically, levels of the scanning signal SEL and the switching signal SWS fall to L level, and then the switching transistors T1, T2 and T6 are turned off together. Thus, the node Ng is electrically isolated from the variable current source 4a. However, even after the electrical isolation, to the gate of the driving transistor T3, a voltage according to data stored in the capacitor C1 is continuously applied. As a result, through a path as shown in FIG. 13(c), the driving current Ioled flows. On an assumption that the driving transistor T3 operates in a saturation region, the driving current Ioled (the channel current Isd of the driving transistor T3) flowing in the organic EL element is calculated by the following equation 5 when a threshold voltage of the driving transistor T3 is Vth3.
Ioled=Isd=½β(Vsg−Vth3)² (Equation 5)

Here, if the voltage Vg calculated by the equation 4 is substituted for the gate voltage of the driving transistor T3, the equation 5 can be transformed to the following equation 6. Moreover, this equation transformation is on an assumption that the threshold voltage Vth3 of the driving transistor T3 and the threshold voltage Vth4 of the programming transistor T4 are the same (Vth3=Vth4=Vth). As regards the transistors T3 and T4 which are manufactured by the same process and arranged very closely to each other on the display unit 1, it is possible to set the electrical characteristics of the transistors T3 and T4 to be almost the same even in the actual product.

$$\begin{matrix}Ioled = 1 / 2 {β ( Vs - Vg - Vth3 )}^{2} \\ = 1 / 2 β {\{ Vdd - ( Vdd - Vth4 - Δ V ) - Vth3 \}}^{2} \\ = 1 / 2 β \cdot Δ {V}^{2} \\ = β / 2 {( Idata \cdot Δ t / C )}^{2}\end{matrix} \qquad ( Equation 6 )$$

In the equation 6, it is important that the Vth3 and Vth4 are balanced each other during the equation transformation. This means that the driving current Ioled to be generated by the driving transistor T3 does not depend on the Vth3 and Vth4. The emitting brightness of the organic EL element OLED is principally determined by the driving current Ioled according to the product of the data current Idata and its supply time Δt, and thus grayscale level of the pixel 2 is set.

According to the present embodiment, like the respective embodiments described above, since it is possible to generate the driving current Ioled which does not depend on the Vth3 and Vth4, it is possible to suppress variation in the driving current Ioled, and further it is possible to perform the precharge to be completed within the pixel 2, even when an additional circuit for the precharge is provided outside the pixel 2.

### Sixth Embodiment

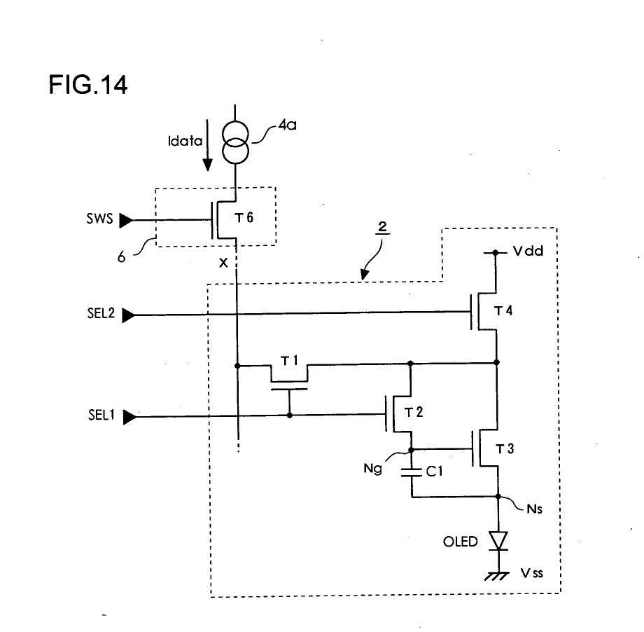

FIG. 14 is a diagram of a pixel circuit according to the present embodiment. One pixel circuit comprises an organic EL element OLED, four n-channel type transistors T1 through T4 and a capacitor C1. In the present embodiment, since it is supposed that the TFT is made of amorphous silicon, the respective transistors are a n-channel type. Further, in this configuration example, the driving transistor T3 functions as a programming element as well as a driving element primarily.

A gate of the switching transistor T1 is connected to the scanning line to which the first scanning signal SEL1 is supplied, and one terminal of the switching transistor T1 is connected to one data line X to which the data current Idata is supplied. Further, the other terminal of the switching transistor T1 is commonly connected to one terminal of the switching transistor T2, one terminal of the driving transistor T3 and one terminal of the switching transistor T4. The gate of the switching transistor T2 is connected to the scanning line to which the first scanning signal SEL1 is supplied, and the other terminal of the switching transistor T2 is connected to the node Ng. The node Ng is commonly connected to one electrode of the capacitor C1 and the gate of the driving transistor T3. The other electrode of the capacitor C1 is connected to a node Ns, and to the node Ns, the other terminal of the driving transistor T3 and the anode of the organic EL element OLED are commonly connected. The cathode of the organic EL element OLED is connected to the Vss terminal to transistor T4 is connected to the scanning line to which the second scanning signal SEL2 is supplied, and the other terminal of the switching transistor T4 is connected to the Vdd terminal to which the power source voltage Vdd is constantly supplied.

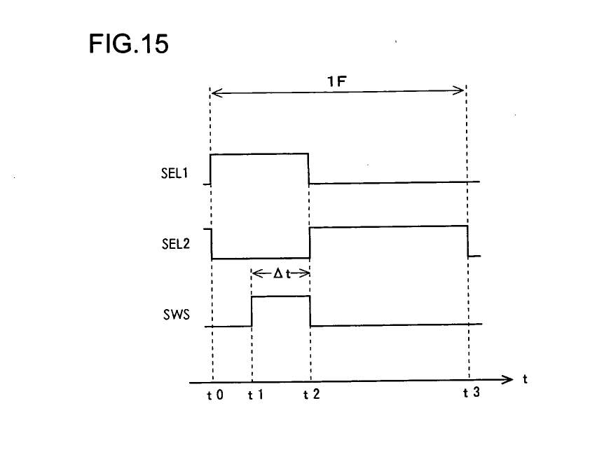

FIG. 15 is a timing chart of operation of the pixel circuit shown in FIG. 14. A period t0-t3 corresponding to one frame period (1F) generally divided into a precharge period t0-t1, a data writing period t1-t2 and a driving period t2-t3.

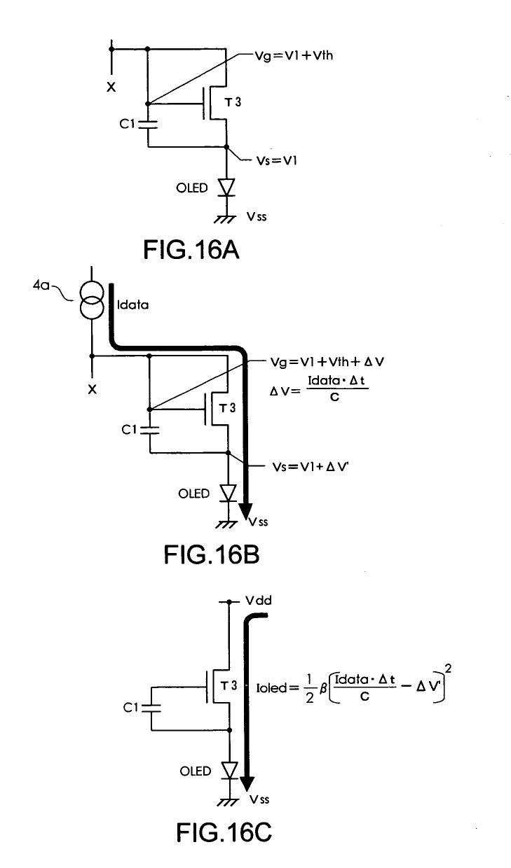

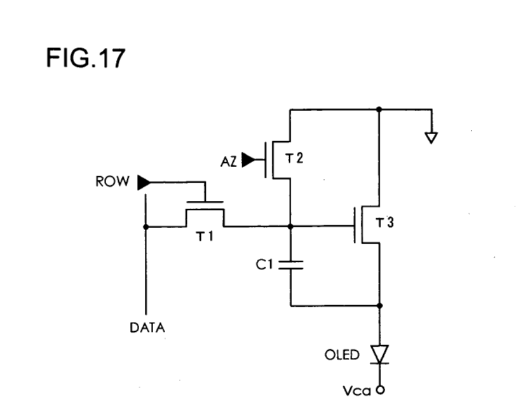

First, in the precharge period t0-t1, the precharge with the Vth compensated is performed. More specifically, the level of the first scanning signal SEL1 becomes H level, and then the switching transistors T1 and T2 are turned on together. Thus, the data line X and the node Ng are electrically connected, and the driving transistor T3 is diode-connected in which its gate and its drain are electrically connected to each other. In this period t0-t1, since the level of the switching signal SWS is L level and the switching transistor T6 is turned off, the node Ng in the pixel 2 and the variable current source 4a are still left to be electrically isolated from each other. Further, since the level of the second scanning signal SEL2 is L level and the switching transistor T4 is turned off, one terminal of the driving transistor T3 and the Vdd terminal are electrically isolated from each other. Thus, as shown in FIG. 16(a), the precharge of the capacitor C1 and the data line X is performed. By this precharge, the voltage of the node Ns becomes V1, and the voltage Vg of the node Ng becomes an offset voltage (V1+Vth) depending on the Vth of the driving transistor T3. Moreover, a specified value of the V1 is depending on a leak current of the organic EL element OLED.

Next, in the data writing period t1-t2, the data writing to the capacitor C1 is performed, based on the offset voltage (V1+Vth) set in the previous precharge period t0-t1. In this period t1-t2, since the levels of the scanning signals SELL and SEL2 are the same as those in the precharge period t0-t1, the switching transistors T1 and T2 are left to be turned on and the switching transistor T4 is left to be turned off. Further, in the timing t1, the level of the switching signal SWS rises to H level, and then the switching transistor T6 which is turned off is switched to be turned on. Thus, as shown in FIG. 16(b), the node Ng and the variable current source 4a are electrically connected to each other. As a result, a path of the data current Idata is formed, and the path is made in a sequence of the variable current source 4a, the channel of the driving transistor T3, the organic EL element OLED and Vdd terminal. As shown in the following equation 7, the voltage Vg of the node Ng is changed by the product of the data current Idata and its supply time Δt, based on the previously set offset voltage (V1+Vth).
Vg=V1+Vth1+ΔV
ΔV=(Idata·Δt)/C (Equation 7)

Further, as shown in the equation 8, the voltage Vs of the node Ns is changed by ΔV′ based on the voltage V1 previously set. The ΔV′ is a voltage depending on characteristics of the organic EL element OLED (V-I characteristic and Idata characteristic).
Vs=V1+ΔV′ (Equation 8)

In the subsequent driving period t2-t3, the driving current Ioled corresponding to the channel current Isd of the driving transistor T3 is supplied to the organic EL element OLED, whereby the organic EL element is emitted. More specifically, levels of the first scanning signal SEL1 and the switching signal SWS fall to L level, and then the switching transistor T1, T2 and T6 are turned off together. Thus, the node Ng is electrically isolated from the variable current source 4a. However, even after the electrical isolation, to the gate of the driving transistor T3, a voltage according to data stored in the capacitor C1 is continuously applied. Further, in synchronization with a falling of the first scanning signal SEL1, the level of the second scanning signal SEL2 rises to H level, and then the switching transistor T4 is turned on. Thus, to one terminal of the driving transistor T3, the power source voltage Vdd is supplied via the vdd terminal. Therefore, through a path as shown in FIG. 16(c), the driving current Ioled flows. On an assumption that the driving transistor T3 operates in a saturation region, the driving current Ioled (the channel current Isd of the driving transistor T3) flowing in the organic EL element OLED is calculated by the following equation 9.
Ioled=Isd=½β(Vgs−Vth)² (Equation 9)

Here, if the voltage Vg calculated by the equation 7 and the voltage Vs calculated by the equation 8 are substituted for the gate voltage of the driving transistor T3, the equation 9 can be transformed to the following equation 10.

$$\begin{matrix}Ioled = 1 / 2 {β ( Vg - Vs - Vth )}^{2} \\ = 1 / 2 β {\{ ( V1 + Vth + Δ V ) - ( V1 + Δ {V}^{′} ) - Vth \}}^{2} \\ = 1 / 2 {β ( Δ V - Δ {V}^{′} )}^{2} \\ = β / 2 {( Idata \cdot Δ t / C - Δ {V}^{′} )}^{2}\end{matrix} \qquad ( Equation 10 )$$

In the equation 10, it is important that the Vths are balanced each other during the equation transformation. This means that the driving current Ioled to be generated by the driving transistor T3 does not depend on the Vth. The emitting brightness of the organic EL element OLED is principally determined by the driving current Ioled according to the product of the data current Idata and its supply time Δt, and thus grayscale level of the pixel 2 is set.

According to the present embodiment, like the respective embodiments, since it is possible to generate the driving current Ioled which does not depend on the Vth, it is possible to suppress variation in the driving current Ioled. At the same time, even when an additional circuit for the precharge is provided outside the pixel 2, it is possible to perform the precharge to be completed with the pixel 2.

Moreover, in the respective embodiments described above, the configuration example of the pixel circuit in which the transistor functioning as the programming element is selectively diode-connected by the control of the switching transistor is described. However, the present invention can also be applied to a pixel circuit in which the transistor functioning as the programming element is normally diode-connected.

Further, in the respective embodiments described above, the example in which the organic EL element is used for the electro-optical device is described. However, the present invention is not limited to the example, but the present invention can be widely applied to an electro-optical device in which the brightness is set according to the driving current (an inorganic LED display device, a field emission display device or the like), or an electro-optical device which exhibits transmittance and reflectance according to the driving current (an electrochromic display device, an electrophoretic display device or the like).

In addition, the electro-optical devices according to the respective embodiments can be mounted on various electronic apparatuses, for example, including a television, a projector, a personal digital assistant, a mobile type computer, a personal computer. If the above-mentioned electro-optical device is mounted on the respective electronic apparatuses, it is possible to increase the product value of the electronic apparatuses still more, and further it is possible to improve the product solicitation power in the market.

1. A method of driving a pixel circuit, comprising:
a first step of setting a gate voltage of a diode-connected first transistor to an offset voltage according to a threshold voltage of the first transistor, in a state in which a variable current source variably generating a data current is electrically isolated from the first transistor;
a second step of writing, in a capacitor connected to a gate of the diode-connected first transistor, data set based on the offset voltage and according to a product of the data current supplied from the variable current source via data lines and a supply time thereof, in a state in which the variable current source and the first transistor are electrically connected to each other; and
a third step of generating a driving current according to the data stored in the capacitor by a second transistor whose gate is connected to the capacitor to set the brightness of an electro-optical device.

2. The method of driving a pixel circuit according to claim 1, wherein a transistor rolls as both the first transistor and the second transistor.

3. The method of driving a pixel circuit according to claim 1, wherein the first transistor and the second transistor constitute a current mirror.

4. The method of driving a pixel circuit according to claim 1, wherein
the first step comprises a step of turning off switching elements provided between the variable current source and the first transistor, and
the second step comprises a step of turning on the switching elements.

5. The method of driving a pixel circuit according to claim 1, further comprising:
a fourth step of regulating the offset voltage set in the first step, by variably controlling the terminal voltage of a capacitor that another terminal is coupled to the data lines.

6. The method of driving a pixel circuit according to claim 5, wherein in the fourth step, the amount of change of the terminal voltage of a capacitor is set according to a grayscale level to be displayed.

7. The method of driving a pixel circuit according to claim 1, further comprising:
prior to setting the offset voltage in the first step, a fifth step of supplying, to the data lines, a predetermined voltage having a voltage level that turns on the first transistor.

8. A pixel circuit comprising:
a first transistor, normally or selectively diode-connected under the control of a switching transistor, for generating data according to a data current supplied from a variable current source via a data line;
a capacitor connected to a gate of the first transistor, in which data generated by the first transistor is written;
a second transistor, whose gate is connected to the capacitor, for generating a driving current according to the data stored in the capacitor; and
an electro-optical element in which the brightness is set according to the driving current generated by the second transistor,
wherein in a state which the first transistor is electrically isolated from the variable current source, the first transistor
sets its gate voltage to an offset voltage according to its threshold voltage, and
wherein in a state which the first transistor is electrically connected to the variable current source, the first transistor
writes, in the capacitor, data set based on the offset voltage and according to a product of the data current supplied from the variable current source and a supply-time thereof.

9. The pixel circuit according to claim 8, wherein a transistor rolls as both the first transistor and the second transistor.

10. The pixel circuit according to claim 9, wherein the first transistor and the second transistor constitute a current mirror.

11. The pixel circuit according to claim 8, further comprising:
a switching circuit for electrically isolating the variable current source from the data lines for a period during which the gate voltage is set to the offset voltage, and electrically connecting the variable current source to the data lines for a period during which the data is written in the capacitor.

12. The pixel circuit according to claim 8, further comprising:
a precharge regulation circuit that regulate the offset voltage by variably controlling the terminal voltage of a capacitor that another terminal is coupled to the data lines.

13. The pixel circuit according to claim 12, wherein the precharge regulation circuit controls the amount of change of the terminal voltage of a capacitor according to a grayscale level to be displayed.

14. The pixel circuit according to claim 8, further comprising:
a precharge acceleration circuit for supplying, to the data lines, a predetermined voltage having a voltage level that turns on the first transistor, prior to a period during which the gate voltage is set to the offset voltage.

15. An electronic apparatus comprising an electro-optical device comprising the pixel circuit as claimed in claim 8.
